(19) United States
(12) Patent Application Publication
(10) Pub. No.: US 2022/0322743 A1
(43) Pub. Date: Oct. 13, 2022

(54) Heater and smoking device including the heater

(71) Applicant: SHENZHEN FIRST UNION TECHNOLOGY CO.,LTD., Shenzhen (CN)

(72) Inventors: Yuanqiu Xie, Shenzhen (CN); Zhiming Lu, Shenzhen (CN); Ruilong Hu, Shenzhen (CN); Wei Chen, Shenzhen (CN); Zhongli Xu, Shenzhen (CN); Yonghai Li, Shenzhen (CN)

(21) Appl. No.: 17/846,082

(22) Filed: Jun. 22, 2022

Related U.S. Application Data
(63) Continuation of application No. PCT/CN2020/138683, filed on Dec. 23, 2020.

(30) Foreign Application Priority Data
Dec. 23, 2019 (CN) 201922332678.0

(51) Int. Cl. A24F 40/46; A24F 40/20; H05B 3/22

(52) U.S. Cl. CPC A24F 40/46; A24F 40/20; H05B 3/22

(57) ABSTRACT

The present application discloses a heater and a smoking device including the heater. The heater includes a heating body, in which a space for containing an aerosol-forming matrix, configured to receive electric power from a power supply to generate heat, and transfer the heat to the aerosol-forming matrix so as to volatilize at least one component in the aerosol-forming matrix; an electrode part including a first electrode and a second electrode arranged on the heating body at intervals and electrically connected with the heating body, configured to feed the electric power to the heating body; and an electrode connector including an abutting part and an extension part; the abutting part abutting against the electrode part to be electrically connected with the electrode part, and the extension part being configured to extend the electrode part to a position far away from the heating body through electrical connection.

### CROSS-REFERENCE TO RELATED APPLICATION

The present application claims priority to Chinese Patent Application No. 2019223326780, filed with the Chinese Patent Office on Dec. 23, 2019, titled “HEATER AND SMOKING DEVICE INCLUDING THE HEATER”, the entire contents of which are incorporated herein by reference.

### TECHNICAL FIELD

The present application relates to the field of smoking devices, and in particular, relates to a heater and a smoking device including the heater.

### BACKGROUND

Smoking articles such as cigarettes and cigars burn tobacco to produce smoke during use. Attempts have been made to provide substitutes for these tobacco-burning articles by producing products that release compounds without burning. Examples of such products are so-called incombustible products which are not incombustible when heated and release compounds by heating instead of burning tobacco.

An existing smoking device which is incombustible when heated at a low temperature mainly operates by coating a far infrared coating and a conductive coating on an outer surface of a base, so that the far infrared coating, after being powered on, emits far infrared rays to penetrate the base and heat an aerosol-forming matrix in the base. As the far infrared rays have strong penetrability, they can penetrate the periphery of aerosol-forming matrix and enter the aerosol-forming matrix so that the aerosol-forming matrix is heated evenly.

In this smoking device, the conductive coating is usually coated on both ends of the base, then conductive rings with notches are respectively sleeved on the conductive coatings, and then external wires are welded on the conductive rings.

### SUMMARY

A first aspect of the present application discloses a heater for heating an aerosol-forming matrix in a smoking device to generate aerosol for smoking. The heater includes: a heating body, in which a space for containing the aerosol-forming matrix is formed; the heating body being configured to receive electric power from a power supply to generate heat, and transfer the heat to the aerosol-forming matrix so as to volatilize at least one component in the aerosol-forming matrix; an electrode part, at least including a first electrode and a second electrode arranged on the heating body at intervals, both the first electrode and the second electrode being electrically connected with the heating body and being configured to feed the electric power to the heating body; and at least one electrode connector, including an abutting part and an extension part; the abutting part abutting against the electrode part to be electrically connected with the electrode part, and the extension part being configured to extend the electrode part to a position far away from the heating body through electrical connection.

A second aspect of the present application discloses a smoking device. The smoking device includes a housing assembly and the heater according to the first aspect; and the heater is arranged in the housing assembly.

### BRIEF DESCRIPTION OF THE DRAWINGS

One or more embodiments are illustrated by pictures in corresponding attached drawings, and this does not constitute limitation on the embodiments. Elements with the same reference numerals in the attached drawings are shown as similar elements, and the pictures in the attached drawings do not constitute scale limitation unless otherwise stated particularly.

FIG. 1 is a schematic view of a heater according to a first embodiment of the present application.

FIG. 2 is an exploded schematic view of FIG. 1.

FIG. 3 is a schematic assembled diagram of some components in FIG. 2.

FIG. 4 is another schematic assembled diagram of some components in FIG. 2.

FIG. 5 is a schematic view of a base in the heater according to the first embodiment of the present application.

FIG. 6 is a schematic view of an electrode connector in the heater according to the first embodiment of the present application.

FIG. 7 is another schematic view of the electrode connector in the heater according to the first embodiment of the present application.

FIG. 8 is yet another schematic view of the electrode connector in the heater according to the first embodiment of the present application.

FIG. 9 is a schematic view of a first fixing seat in the heater according to the first embodiment of the present application.

FIG. 10 is a schematic view of a second fixing seat in the heater according to the first embodiment of the present application.

FIG. 11 is another schematic view of the base in the heater according to the first embodiment of the present application.

FIG. 12 is another schematic view of the heater according to the first embodiment of the present application.

FIG. 13 is a schematic view of a smoking device according to a second embodiment of the present application.

FIG. 14 is an exploded schematic view of FIG. 13.

### DETAILED DESCRIPTION

In order to facilitate the understanding of the present application, the present application will be explained in more detail below with reference to the attached drawings and the detailed description. It shall be noted that, when an element is expressed as “fixed to” another element, it may be directly on another element, or there may be one or more intervening elements therebetween. When an element is expressed as “connected” to another element, it may be directly connected to another element, or there may be one or more intervening elements therebetween. Terms such as “up”, “down”, “left”, “right”, “inside”, “outside” and other similar expressions used in this specification are for illustrative purposes only.

Unless otherwise defined, all technical and scientific terms used in this specification have the same meanings as commonly understood by those skilled in the art of the present application. In this specification, the terms used in the specification of the present application are only for the purpose of describing specific embodiments, and are not intended to limit the present application. The term “and/or” used in this specification comprises any and all combinations of one or more related items listed.

The traditional smoking device has a problem of inconvenient operation caused by welding wires on the conductive rings. Accordingly, the heater and the smoking device including the heater according to the present application facilitate wire welding and improve the assembly efficiency of the smoking device by electrically connecting the electrode connector with the electrode and extending the electrode to a position far away from the base.

### First Embodiment

A heater according to the first embodiment of the present application is used for heating an aerosol-forming matrix in a smoking device to generate aerosol for smoking. The heater 1 includes a heating body and an electrode part.

The heating body is formed therein with a space for containing the aerosol-forming matrix; the heating body is configured to receive electric power from a power supply to generate heat, and transfer the heat to the aerosol-forming matrix so as to volatilize at least one component in the aerosol-forming matrix;

The electrode part at least includes a first electrode and a second electrode arranged on the heating body at intervals, both the first electrode and the second electrode are electrically connected with the heating body and are configured to feed the electric power to the heating body.

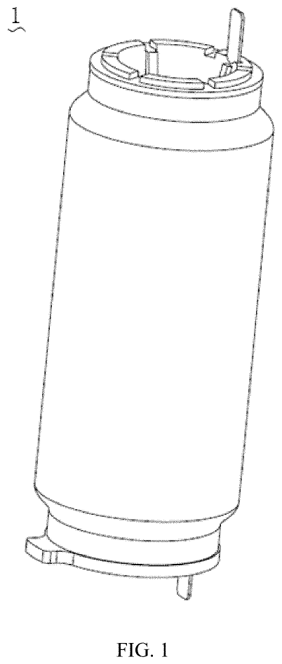

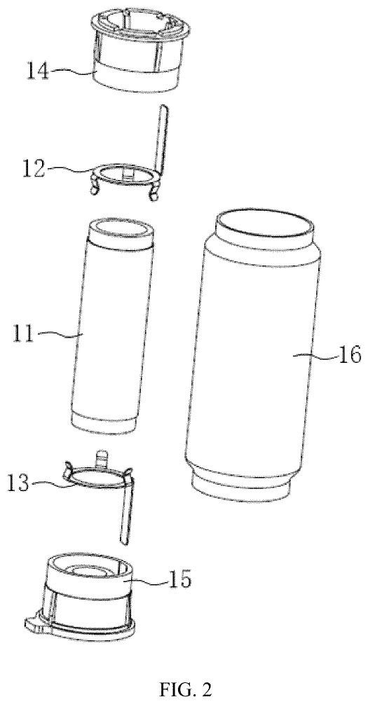

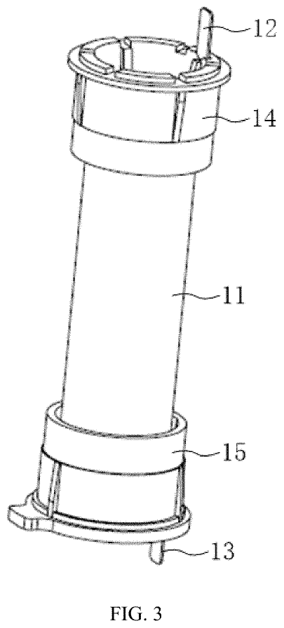

As shown in FIG. 1 to FIG. 10, in one example, the heating body includes a base 111 and an infrared electrothermal coating 112, and the electrode portion includes a first electrode 113 and a second electrode 114.

A cavity adapted for containing the aerosol-forming matrix is formed in the base 111.

Specifically, the base 111 has first and second ends which are opposite to each other, and the base 111 extends in the longitudinal direction between the first and second ends, and the base 111 is hollow inside to form a cavity adapted for containing the aerosol-forming matrix. The base 111 may be in cylindrical, prismatic or other columnar shapes. The base 111 is preferably cylindrical, then the cavity is a cylindrical hole penetrating through the middle of the base 111, and the inner diameter of the hole is slightly larger than the outer diameter of an aerosol-forming article or a smoking article, so that it is convenient to place the aerosol-forming article or the smoking article in the cavity to be heated.

The base 111 may be made of high-temperature resistant and transparent materials such as quartz glass, ceramic or mica, or other materials with higher infrared transmittance, such as high-temperature resistant materials with infrared transmittance of more than 95%, and this is not limited herein.

The aerosol-forming matrix is a matrix which can release volatile compounds capable of forming the aerosol. This kind of volatile compounds can be released by heating the aerosol-forming matrix. The aerosol-forming matrix may be a solid or a liquid or include solid and liquid components. The aerosol-forming matrix may be adsorbed, coated, impregnated or otherwise loaded on a carrier or support. The aerosol-forming matrix may conveniently be a part of an aerosol-generating article or a smoking article.

The aerosol-forming matrix may include nicotine. The aerosol-forming matrix may include tobacco, for example, a tobacco-containing material containing a volatile compound with a tobacco flavor, and the volatile compound with the tobacco flavor is released from the aerosol-forming matrix when it is heated. A preferred aerosol-forming matrix may include a homogeneous tobacco material, such as deciduous tobacco. The aerosol-forming matrix may include at least one aerosol-forming agent, which may be any suitable and known compound or a mixture of compounds. During use, the compound or the mixture of compounds is conducive to the formation of dense and stable aerosol, and is basically resistant to thermal degradation at the operating temperature of the aerosol-generating system. Suitable aerosol-forming agents are well known in the art and include but are not limited to: polyols such as triethylene glycol, 1,3-butanediol and glycerol; esters of polyols, such as glycerol monoacetate, glycerol diacetate or glycerol triacetate; and fatty acid esters of mono-carboxylic acids, di-carboxylic acids or poly-carboxylic acids, such as dimethyl dodecanedioate and dimethyl tetradecanedioate. The preferred aerosol-forming agent is polyhydric alcohols or a mixture thereof, such as triethylene glycol, 1,3-butanediol and the most preferred glycerine.

The infrared electrothermal coating 112 is coated on the surface of the base 111. The infrared electrothermal coating 112 may be coated on the outer surface of the base 111 or on the inner surface of the base 111. Preferably, the infrared electrothermal coating 112 can be coated on the outer surface of the base 111.

The infrared electrothermal coating 112 can generate heat energy when it is powered on so as to generate infrared rays with a certain wavelength, for example, far infrared rays of 8 μm to 15 μm. When the wavelength of the infrared rays matches the absorption wavelength of the aerosol-forming matrix, the energy of the infrared rays is easily absorbed by the aerosol-forming matrix. In the embodiment of the present application, the wavelength of the infrared rays is not limited, but the infrared rays may be infrared rays of 0.75 μm to 1,000 μm, and preferably far infrared rays of 1.5 μm to 400 μm.

The infrared electrothermal coating 112 is preferably prepared by coating far infrared electrothermal ink, ceramic powder and inorganic adhesive, which are fully and uniformly stirred, on the outer surface of the base 111, and then drying and curing the resultant for a certain time. The thickness of the infrared electrothermal coating 112 is 30 μm to 50 μm. Of course, the infrared electrothermal coating 112 may also be prepared by coating tin tetrachloride, tin oxide, antimony trichloride, titanium tetrachloride and anhydrous copper sulfate, which are mixed at a certain proportion and stirred, on the outer surface of the base 111. Alternatively, the infrared electrothermal coating 112 is one of a silicon carbide ceramic layer, a carbon fiber composite layer, a zirconium titanium oxide ceramic layer, a zirconium titanium nitride ceramic layer, a zirconium titanium boride ceramic layer, a zirconium titanium carbide ceramic layer, an iron oxide ceramic layer, an iron nitride ceramic layer, an iron boride ceramic layer, an iron carbide ceramic layer, a rare earth oxide ceramic layer, a rare earth nitride ceramic layer, a rare earth boride ceramic layer, a rare earth carbide ceramic layer, a nickel cobalt oxide ceramic layer, a nickel cobalt nitride ceramic layer, a nickel cobalt boride ceramic layer, a nickel cobalt carbide ceramic layer or a high-silica zeolite ceramic layer. The infrared electrothermal coating 112 may also be an existing coating of other materials.

In an example, the infrared electrothermal coating 112 is coated on the inner surface of the base 111, and the heater 1 further includes a protective layer (not shown in the figure) coated on the infrared electrothermal coating 112 and/or a protective structure provided on the infrared electrothermal coating 112. The protective layer may be one or a combination of a polytetrafluoroethylene layer and a glaze layer, or a protective layer made of other high-temperature resistant materials. The protective structure may be an assembly or component that separates the aerosol-forming article or the smoking article from the infrared electrothermal coating 112, and there may be a gap between the protective structure and the infrared electrothermal coating 112 or the aerosol-forming article. The protective layer and/or the protective structure can avoid the abrasion of the infrared electrothermal coating 112 caused by for example the movement of the aerosol forming article (e.g., a cigarette) into and out of the cavity.

Both the first electrode 113 and the second electrode 114 are at least partially and electrically connected with the infrared electrothermal coating 112 so that current can flow from one electrode to the other electrode through the infrared electrothermal coating 112. The polarities of the first electrode 113 and the second electrode 114 are opposite. For example, the first electrode 113 is a positive electrode while the second electrode 114 is a negative electrode. Alternatively, the first electrode 113 is a negative electrode while the second electrode 114 is a positive electrode. Preferably, the infrared electrothermal coating 112 is coated on the outer surface of the base 111, the first electrode 113 is disposed on the outer surface of the base 111 near the first end, and the second electrode 114 is disposed on the outer surface of the base 111 near the second end.

In this example, both the first electrode 113 and the second electrode 114 are annular (ring-shaped electrodes). The first electrode 113 and the second electrode 114 may be annular conductive coatings coated on the outer surface of the base 111 near the first end and the second end. The conductive coatings may be metal coatings or conductive tapes, and the metal coatings may include silver, gold, palladium, platinum, copper, nickel, molybdenum, tungsten, niobium or an alloy material of the above metals. Reference may be made to 11 in FIG. 5 for the whole structure constituted by the base 111, the infrared electrothermal coating 112, the first electrode 113 and the second electrode 114. In other examples, the first electrode 113 and the second electrode 114 may also be annular conductive sheets sleeved on the outer surface of the base 111 near the first end and the second end, and the conductive sheets are metal conductive sheets, such as copper sheets, steel sheets or the like.

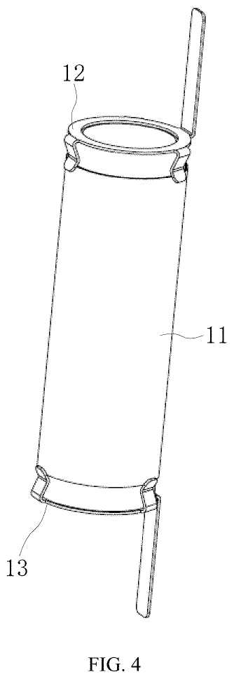

In this example, the heater 1 further includes an electrode connector 12 and an electrode connector 13, which are electrically connected with the first electrode 113 and the second electrode 114 respectively, and extend the first electrode 113 and the second electrode 114 to positions far away from the base 111 respectively. In this example, the electrode connector 12 and the electrode connector 13 have the same structure, and are assembled on the base 111 in the opposite directions, as shown in FIG. 4.

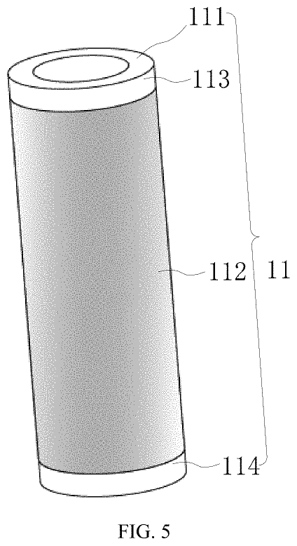

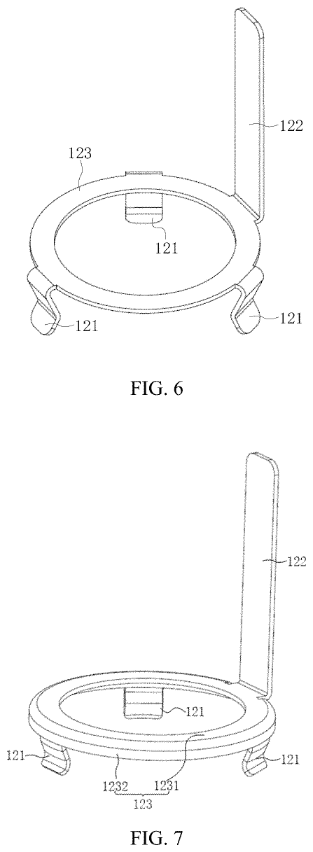

Taking the electrode connector 12 as an example, as shown in FIG. 6, the electrode connector 12 includes abutting parts (121, 123) and an extension part 122. The abutting parts (121, 123) comprise a body 123 and three elastic contacting parts 121 connected with the body 123.

The shape of the body 123 matches that of the end of the base 111, and specifically, the body 123 is formed in a ring shape. The ring-shaped body 123 performing position limiting by abutting against the end surface of the heating body. That is, the body 123 constitutes a position-limiting part for limiting the relative positions of the abutting parts (121, 123) and the base 111 so that the elastic contacting part 121 is positioned at the position of the first electrode 113.

The three elastic contacting parts 121 are arranged on the body 123 at equal intervals. In other examples, the elastic contacting parts 121 may also be arranged on the body 123 at unequal intervals. The number of the elastic contacting parts 121 is not limited, and it may be 1, 2, 3, 4, 5, 6, 7 or 8. As shall be appreciated, the multiple elastic contacting parts 121 are helpful for reliable electrical connection of electrodes, but they increase the processing cost, and those skilled in the art can choose the elastic contacting parts 121 according to needs. As shall be appreciated, although the electrical connection with the electrode part may be realized even when the number of the elastic contacting parts 121 is one or two, from the viewpoints of convenience in use and stable connection, it is preferable to use more than three elastic contacting parts 121. The abutting parts (121, 123) are fixed on the first electrode 113 by the elastic force of the three elastic contacting parts 121. The elastic contacting part 121 includes at least one cantilever connected to the body 123, and the cantilever is pre-deformed to form the elastic contacting part 121 so that it can generate an elastic force when abutting against the first electrode 113, thereby realizing the electrical connection with the first electrode 113. The cantilever generally extends along the axial direction of the body 123 to facilitate assembly. The extension part 122 extends from the body 123 in a direction away from the base 111.

Referring to FIG. 7, in an example, the body 123 includes a position-limiting part 1231 and a sleeving part 1232. The position-limiting part 1231 abuts against the end face of the heating body for position limiting, and the sleeving part 1232 is sleeved with the base 111. By the position-limiting part 1231 and the sleeving part 1232, the relative positions of the abutting parts (121, 123) and the base 111 are limited so that the elastic contacting part 121 is positioned at the position of the first electrode 113.

The elastic contacting part 121 includes at least one cantilever extending axially to the edge of the sleeving part 1232. The cantilever is pre-deformed so that it can generate an elastic force when abutting against the first electrode 113, thereby realizing the electrical connection with the first electrode 113.

It shall be noted that, in alternative embodiment, the position-limiting part 1231 could be omitted.

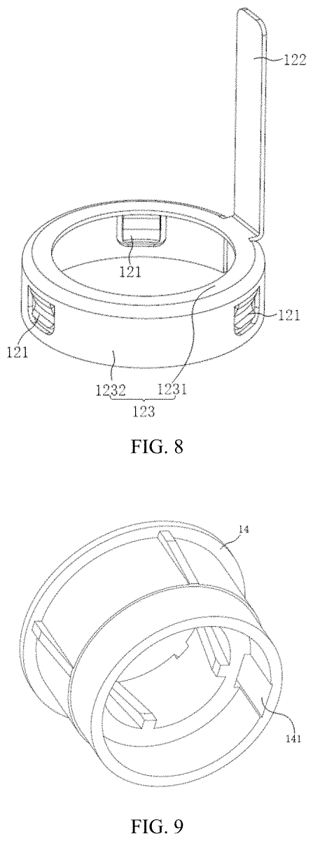

Referring to FIG. 8, an example differs from the example of FIG. 7 in that the elastic contacting part 121 includes at least one cantilever formed on the sleeving part 1232 through hollowing, and the cantilever is pre-deformed so that it can generate an elastic force when abutting against the first electrode 113, thereby realizing electrical connection with the first electrode 113.

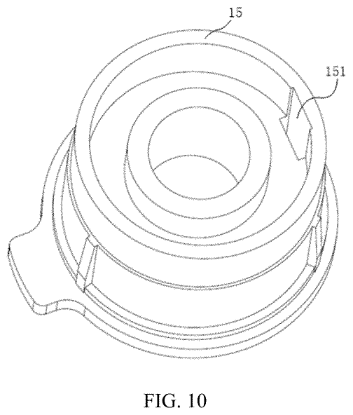

In this example, the heater 1 further includes a first fixing seat 14 and a second fixing seat 15. The first fixing seat 14 and the second fixing seat 15 are respectively fixed at both ends of the base 111. The first fixing seat 14 and the second fixing seat 15 each comprise a lead-out part for leading out the extension parts of the electrode connector 12 and the electrode connector 13. Referring to FIG. 9 and FIG. 10 for appreciation, the leading-out parts of the first fixing seat 14 and the second fixing seat 15 are respectively through holes 141 and 151.

As shall be appreciated, at least one electrode connector (12, 13) and the fixing seats may also be integrally formed, for example, by being fixed together or by being formed as a whole structure when the fixing seats (14, 15) are molded. The heat body is connected with the fixing seat by being inserted into the fixing seat, and meanwhile, the electric connection between the electrode part of the heating body and the at least one electrode connector (12, 13) is realized.

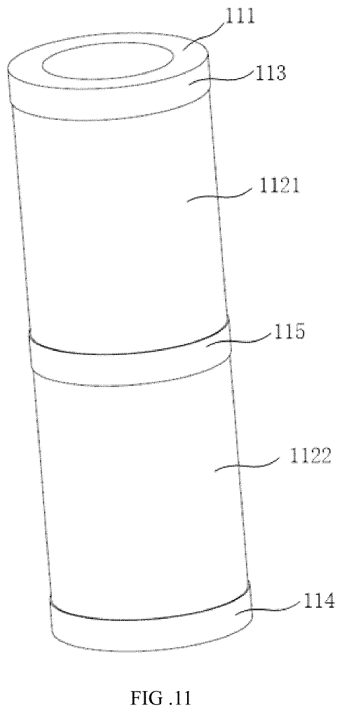

Referring to FIG. 11, in another example, the heater 1 further includes a third electrode 115 disposed on the base 111, and the third electrode 115 is located between the first electrode 113 and the second electrode 114. The third electrode 115 divides the infrared electrothermal coating 112 into two independent heating areas (1121, 1122) along the longitudinal direction of the base 111, so as to realize segmented heating of the aerosol-forming matrix.

Further speaking, the third electrode 115 may be extended to a position far away from the base 111 by electrically connecting the electrode connector with the third electrode 115.

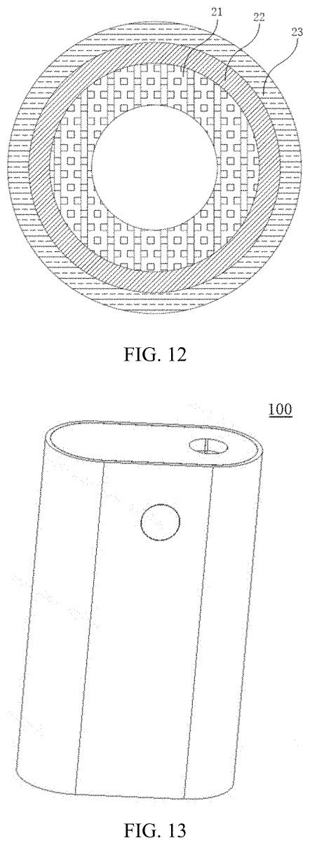

Further referring to FIG. 12, in another example, the heating body includes a base 21 and an infrared radiation layer 22.

Reference may be made to the description of the above-mentioned base for the base 21, and this will not be further described herein.

The infrared radiation layer 22 is formed on the outer surface of the base 21. The infrared radiation layer 22 may be formed on the outer surface of the base 21 or formed on the inner surface of the base 21. The infrared radiation layer 22 is preferably formed on the outer surface of the base 21.

The temperature of the infrared radiation layer 22 may be raised to generate infrared rays of a certain wavelength, such as far infrared rays of 8 μm to 15 μm, after the infrared radiation layer 22 absorbs heat. When the wavelength of the infrared rays matches the absorption wavelength of the aerosol-forming matrix, the energy of the infrared rays is easily absorbed by the aerosol-forming matrix. In this example, the wavelength of the infrared rays is not limited, and the infrared rays may be infrared rays of 5 μm to 15 μm, and preferably far infrared rays of 8 μm to 15 μm.

The infrared radiation layer 22 may be made of oxides, carbon materials, carbides, nitrides and other materials with high infrared radiance. The materials are specifically as follows.

The metal oxides and multicomponent alloy oxides include: ferric oxide, aluminum oxide, chromium oxide, indium oxide, lanthanum oxide, cobaltic oxide, nickel oxide, antimony oxide, antimony pentoxide, titanium dioxide, zirconium dioxide, manganese dioxide, cerium dioxide, copper oxide, zinc oxide, magnesium oxide, calcium oxide, molybdenum trioxide or the like; or a combination of two or more metal oxides described above; or a ceramic material with a unit cell structure such as spinel, perovskite and olivine.

The emissivity of carbon materials is close to that of a blackbody, and the carbon materials have a higher infrared radiance. The carbon materials includes: graphite, carbon fiber, carbon nanotubes, graphene, diamond-like carbon thin films or the like.

The carbides include: silicon carbide, which has high emissivity in a large infrared wavelength range (2.3 microns to 25 microns) and is a preferred near-full-band infrared radiation material; in addition, the carbides include tungsten carbide, iron carbide, vanadium carbide, titanium carbide, zirconium carbide, manganese carbide, chromium carbide, niobium carbide or the like, all of which have high infrared emissivity (MeC phase does not have strict chemical calculation composition and chemical formula).

The nitrides include metal nitrides and nonmetal nitrides, wherein the metal nitrides include titanium nitride, titanium carbonitride, aluminum nitride, magnesium nitride, tantalum nitride, vanadium nitride or the like, and the nonmetal nitrides include boron nitride, phosphorus nitride, silicon nitride (Si3N4) or the like.

Other inorganic nonmetallic materials include: silica, silicate (including phosphosilicate, borosilicate or the like), titanate, aluminate, phosphate, boride, chalcogenide or the like.

The electrothermal part 23 is disposed on the outer surface of the base 111. The electrothermal part 23 is used for receiving electric power to generate heat and transfer the heat generated to the infrared radiation layer 22. The infrared radiation layer 22 is used to receive the heat transferred by the electrothermal part 23 to generate infrared rays, and at least transfer the energy of the infrared rays to the aerosol-forming matrix by radiation.

In this example, the electrothermal part 23 includes a resistive heating layer (not shown in the figure) formed on the infrared radiation layer 22, a first electrode and a second electrode electrically connected with the resistive heating layer. The first electrode and the second electrode are used for feeding the electric power of the power supply to the resistive heating layer to generate heat.

The shape of the resistive heating layer is not limited here, and it may be spiral around the surface of the base 21 or cover the surface of the base 21.

The resistive heating layer may be made of metal materials, carbon materials and semiconductor materials or the like. Specifically, the conductive metal materials include: aluminum, copper, titanium, chromium, silver, iron, nickel or the like; or alloy components of the above metals, such as stainless steel, Fe—Cr—Al alloy, Ni—Cr alloy, Ni—Fe alloy or the like; the carbon materials include: graphite, conductive diamond-like carbon, carbon fiber, carbon nanotubes, grapheme or the like; the semiconductor materials include indium tin oxide, nickel oxide, silicon carbide, aluminum nitride, gallium nitride, doped tin oxide, zinc oxide, and doped zinc oxide, such as AZO, GZO, IZO, B-doped, N-doped, P-doped, As-doped, Sb-doped, Mo-doped, La-doped, IA (Li, Na, K)-doped, D3 (Au, Ag, Cu)-doped elements or the like.

According to the requirements of heating temperature and power, the appropriate resistive heating layer material is selected to form a resistance film with appropriate thickness, and obtain the appropriate resistance range. The resistance value of the resistive heating layer may be 0.1Ω to 10Ω, preferably 0.3Ω to 8Ω, more preferably 0.5Ω to 5Ω, and even more preferably 0.6Ω to 3.5Ω.

In this example, the resistive heating layer is deposited on the infrared radiation layer 22 by physical vapor deposition, and the infrared radiation layer 22 is deposited on the surface of the base 21 by physical vapor deposition.

It shall be noted that, in other embodiments, the electrothermal part 23 may be a heating piece that may be separated from the infrared radiation layer 22, such as a ceramic heating piece sleeved outside the infrared radiation layer 22, a metal heating piece sleeved outside the infrared radiation layer 22, a heating wire wound around the infrared radiation layer 22, an FPC heating film coated outside the infrared radiation layer 22 or the like.

### Second Embodiment

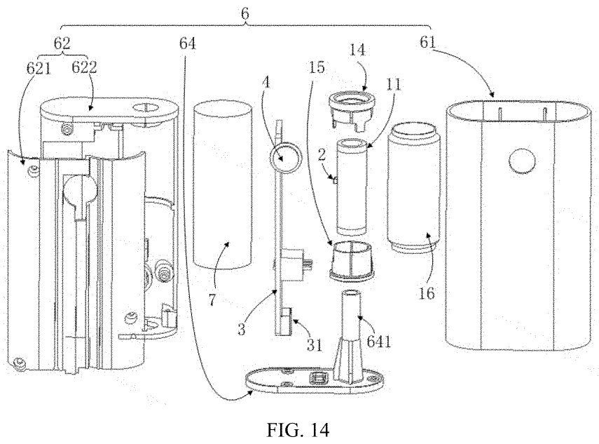

FIG. 13 to FIG. 14 show a smoking device 100 provided according to the second embodiment of the present application, which includes a housing assembly 6 and the heater 1 described above, and the heater 1 is arranged in the housing assembly 6. In the smoking device 100 according to this embodiment, the infrared electrothermal coating 112 and the first electrode 113 and the second electrode 114 electrically connected with the infrared electrothermal coating 112 are arranged on the outer surface of the base 111, and the infrared electrothermal coating 112 can emit infrared rays to radiate and heat the aerosol-forming matrix in the cavity of the base 111.

The housing assembly 6 includes an outer shell 61, a fixing housing 62, fixing seats (14, 15) and a bottom cover 64. The fixing housing 62 and the fixing seats (14, 15) are all fixed in the outer shell 61, wherein the fixing seats (14, 15) are used for fixing the base 111, the fixing seats (14, 15) are arranged in the fixing housing 62, and the bottom cover 64 is arranged on one end of the outer shell 61 and covers the outer shell 61. Specifically, the fixing seats (14, 15) comprise a first fixing seat 14 and a second fixing seat 15, both of which are arranged in the fixing housing 62. The first and second ends of the base 111 are fixed on the first fixing seat 14 and the second fixing seat 15, respectively. The bottom cover 64 is convexly provided with an air inlet pipe 641, and one end of the second fixing seat 15 facing away from the first fixing seat 14 is connected with the air inlet pipe 641. The first fixing seat 14, the base 111, the second fixing seat 15 and the air inlet pipe 641 are coaxially arranged, and the base 111 is sealed with the first fixing seat 14 and the second fixing seat 15, the second fixing seat 15 is also sealed with the air inlet pipe 641, and the air inlet pipe 641 is in communication with the outside air to facilitate smooth air intake when the user smokes.

The smoking device 100 further includes a main control circuit board 3 and a battery 7. The fixing housing 62 includes a front housing 621 and a rear housing 622, the front housing 621 is fixedly connected with the rear housing 622, the main control circuit board 3 and the battery 7 are both arranged in the fixing housing 62, the battery 7 is electrically connected with the main control circuit board 3, and a key 4 is convexly arranged on the outer shell 61. By pressing the key 4, the infrared electrothermal coating 112 on the surface of the base 111 may be powered on or powered off. The main control circuit board 3 is further connected with a charging interface 31, and the charging interface 31 is exposed on the bottom cover 64. The user can charge or upgrade the smoking device 100 through the charging interface 31 to ensure the continuous use of the smoking device 100.

The smoking device 100 further includes a heat insulation pipe 16, which is arranged in the fixing housing 62. The heat insulation pipe 16 is arranged on the periphery of the base 111, and it can prevent a large amount of heat from being transferred to the outer shell 61, which otherwise would cause the user to feel hot. The heat insulation pipe includes heat insulation materials, which may be heat insulation glue, aerogel, aerogel felt, asbestos, aluminum silicate, calcium silicate, diatomite, zirconia or the like. The heat insulation pipe may also include a vacuum heat insulation pipe. The heat insulation pipe 16 may further be coated therein with an infrared reflection coating to reflect the infrared rays emitted by the infrared electrothermal coating 112 on the base 111 back to the infrared electrothermal coating 112 and improve the heating efficiency.

The smoking device 100 further includes a temperature sensor, such as a NTC temperature sensor 2, for detecting the real-time temperature of the base 111 and transmitting the detected real-time temperature to the main control circuit board 3, and the main control circuit board 3 adjusts the magnitude of the current flowing through the infrared electrothermal coating 112 according to the real-time temperature. Specifically, when it is detected by the NTC temperature sensor 2 that the real-time temperature inside the base 111 is low, for example, when it is detected that the temperature inside the base 111 is lower than 150° C., then the main control circuit board 3 controls the battery 7 to output a higher voltage to the electrode, thereby increasing the current fed into the infrared electrothermal coating 112, increasing the heating power of the aerosol-forming matrix, and reducing the waiting time for the user to take the first puff. When it is detected by the NTC temperature sensor 2 that the temperature of the base 111 is 150° C. to 200° C., the main control circuit board 3 controls the battery 7 to output a normal voltage to the electrode. When it is detected by the NTC temperature sensor 2 that the temperature of the base 111 is 200° C. to 250° C., the main control circuit board 3 controls the battery 7 to output a lower voltage to the electrode. When it is detected by the NTC temperature sensor 2 that the temperature inside the base 111 is above 250° C., the main control circuit board 3 controls the battery 7 to stop outputting voltage to the electrodes.

It shall be noted that, the specification and attached drawings of the present application show preferred embodiments of the present application. However, the present application can be implemented in many different forms, and it is not limited to the embodiments described in this specification. These embodiments are not construed as additional restrictions on the content of the present application, but are provided for a more thorough and comprehensive understanding of the disclosure of the present application. In addition, the above technical features continue to be combined with each other to form various embodiments not listed above, all of which are regarded as within the scope described in the specification of the present application. Further speaking, those of ordinary skill in the art can make improvements or variations according to the above description, and all these improvements and variations shall fall within the scope claimed in the appended claims of the present application.

What is claimed is:

1. A heater, comprising:
a heating body, in which a space for containing an aerosol-forming matrix is formed; the heating body being configured to receive electric power from a power supply to generate heat, and transfer the heat to the aerosol-forming matrix so as to volatilize at least one component in the aerosol-forming matrix;
an electrode part, at least comprising a first electrode and a second electrode arranged on the heating body at intervals, both the first electrode and the second electrode being electrically connected with the heating body and configured to feed the electric power to the heating body; and
at least one electrode connector, comprising an abutting part and an extension part; the abutting part abutting against the electrode part to be electrically connected with the electrode part, and the extension part being configured to extend the electrode part to a position far away from the heating body through electrical connection.

2. The heater according to claim 1, wherein the heating body presents a tubular shape and has a first end and a second end opposite to the first end, the first electrode is arranged at the first end and the second electrode is arranged at the second end;
wherein the abutting part comprises a body and an elastic contacting part connected with the body, and the abutting part is mounted on the electrode part by the elastic force of the elastic contacting part; and
the extension part extends from the body in the direction away from the heating body.

3. The heater according to claim 2, wherein the body is formed in an annular shape, and the elastic contacting part comprises at least one cantilever connected with the body, and the cantilever is pre-deformed so as to generate an elastic force for realizing electrical connection with the electrode part, when abutting against the electrode part.

4. The heater according to claim 3, wherein the number of the elastic contacting part is at least three.

5. The heater according to claim 4, wherein the cantilever extends generally along the axial direction of the body.

6. The heater according to claim 5, wherein the electrode connector is formed with a position-limiting part, which is used for limiting the relative positions of the abutting part and the heating body so as to locate the elastic contacting part at the position of the electrode part.

7. The heater according to claim 6, wherein the body constitutes the position-limiting part, and the body performing position limiting by abutting against an end face of the heating body.

8. The heater according to claim 7, wherein the body matches the shape of the end of the heating body.

9. The heater according to claim 5, wherein the body is sleeved with the heating body, and the elastic contacting part comprises at least one cantilever formed on the body through hollowing or at least one cantilever extending from an edge of the body.

10. The heater according to claim 4, wherein the elastic contacting parts are arranged on the body at equal intervals.

11. The heater according to claim 1, wherein the heater further comprises a first fixing seat and a second fixing seat; and
the first fixing seat and the second fixing seat are respectively fixed at both ends of the heating body; both the first fixing seat and the second fixing seat comprise a lead-out part for leading out the extension part.

12. The heater according to claim 11, wherein the lead-out part is a through hole.

13. The heater according to claim 1, wherein the heating body comprises:
a base, in which the space is formed;
an infrared electrothermal coating formed on the base; the infrared electrothermal coating is configured to receive the electric power to generate heat so as to generate infrared rays, and at least transfer the energy of the infrared rays to the aerosol-forming matrix by radiation.

14. The heater according to claim 1, wherein the heating body comprises:
a base, in which the space is formed;
an infrared radiation layer formed on the base;
an electrothermal part arranged on the infrared radiation layer;
wherein the electrothermal part is configured to receive the electric power to generate heat and transfer the heat generated to the infrared radiation layer; the infrared radiation layer is configured to receive the heat transferred by the electrothermal part to generate infrared rays, and at least transfer the energy of the infrared rays to the aerosol-forming matrix by radiation.

15. The heater according to claim 1, wherein the electrode part further comprises at least one third electrode arranged on the heating body, the third electrode is located between the first electrode and the second electrode, and
at least one third electrode divides the heating body into at least two independent heating areas along the longitudinal direction of the base, so as to realize segmented heating of the aerosol-forming matrix;
wherein the electrode connector is electrically connected with at least one third electrode and extends the at least one third electrode to a position far away from the heating body.

16. A smoking device, comprising a housing assembly and a heater arranged in the housing assembly;
wherein the heater comprises:
a heating body, in which a space for containing an aerosol-forming matrix is formed; the heating body being configured to receive electric power from a power supply to generate heat, and transfer the heat to the aerosol-forming matrix so as to volatilize at least one component in the aerosol-forming matrix;
an electrode part, at least comprising a first electrode and a second electrode arranged on the heating body at intervals, both the first electrode and the second electrode being electrically connected with the heating body and configured to feed the electric power to the heating body; and
at least one electrode connector, comprising an abutting part and an extension part; the abutting part abutting against the electrode part to be electrically connected with the electrode part, and the extension part being configured to extend the electrode part to a position far away from the heating body through electrical connection.

17. The smoking device according to claim 16, wherein the heating body presents a tubular shape and has a first end and a second end opposite to the first end, the first electrode is arranged at the first end of the heating body and the second electrode is arranged at the second end of the heating body;
the abutting part comprises a body and an elastic contacting part connected with the body, and the abutting part is mounted on the electrode part by the elastic force of the elastic contacting part;
the extension part extends from the body in the direction away from the heating body.

18. The smoking device according to claim 16, wherein the heating body comprises:
a base, in which the space is formed;
an infrared electrothermal coating formed on the base; the infrared electrothermal coating is configured to receive the electric power to generate heat so as to generate infrared rays, and at least transfer the energy of the infrared rays to the aerosol-forming matrix by radiation.

19. The smoking device according to claim 16, wherein the heating body comprises:
a base, in which the space is formed;
an infrared radiation layer formed on the base;
an electrothermal part arranged on the infrared radiation layer;
wherein the electrothermal part is configured to receive the electric power to generate heat and transfer the heat generated to the infrared radiation layer; the infrared radiation layer is configured to receive the heat transferred by the electrothermal part to generate infrared rays, and at least transfer the energy of the infrared rays to the aerosol-forming matrix by radiation.

20. The smoking device according to claim 16, wherein the smoking device further comprises a hollow heat insulation pipe arranged on the periphery of the base; and
the heat insulation pipe is configured to at least partially prevent the conduction of heat from the heater to the housing assembly.
